(19) United States
(12) Patent Application Publication
(10) Pub. No.: US 2026/0158533 A1
(43) Pub. Date: Jun. 11, 2026

(54) IN-SITU ULTRAFINE BUBBLE CIRCULATION SYSTEM

(71) Applicant: YUH SHAN ENVIRONMENTAL ENGINEERING CO., LTD., Kaohsiung City (TW)

(72) Inventors: Wen-Hsien TSAI, Kaohsiung City (TW); Kuan-Hung WU, Kaohsiung City (TW); Yuan-Hung LIU, Kaohsiung City (TW); Yu-Chi CHANG, Kaohsiung City (TW); Bo-Lin SIE, Kaohsiung City (TW)

(21) Appl. No.: 19/260,648

(22) Filed: Jul. 7, 2025

(30) Foreign Application Priority Data
Dec. 10, 2024 (TW) 113147942

(51) Int. Cl. B09C 1/00; B01D 17/02; B01D 17/12; C02F 1/24; C02F 3/20; C02F 101/32; C02F 103/06

(52) U.S. Cl. CPC B09C 1/002; B01D 17/0205; B01D 17/12; C02F 1/24; C02F 3/20; C02F 2101/32; C02F 2103/06

(57) ABSTRACT

An in-situ ultrafine bubble circulation system includes a pumping well, a pump, an air compressor, a plurality of venture tubes, a remediation well, a hydrocyclone nozzle, and a well screen. The pumping well and the remediation well are drilled beneath a ground surface. The pump is configured to pump the groundwater from beneath the ground surface through a pipeline. The air compressor is configured to inject gas into the groundwater within the pipeline. The plurality of venture tubes is configured to form a plurality of first ultrafine bubbles in the groundwater. The hydrocyclone nozzle is configured to change the plurality of first ultrafine bubbles into a plurality of second ultrafine bubbles. The well screen is configured to change the plurality of second ultrafine bubbles into a plurality of third ultrafine bubbles.

### CROSS-REFERENCE TO RELATED APPLICATION

This application claims priority to Taiwan Application Serial Number 113147942, filed Dec. 10, 2024, which is herein incorporated by reference in its entirety.

### BACKGROUND

### Field of Invention

The present disclosure relates to an in-situ ultrafine bubble circulation system. More particularly, the present disclosure relates to the in-situ ultrafine bubble circulation system for groundwater remediation.

### Description of Related Art

In cases where wastewater and solid waste pollute the soil and subsequently infiltrate into the groundwater, remediation of both media is necessary to prevent further site contamination and associated environmental impacts. Groundwater remediation can be classified into off-site remediation and on-site remediation. Off-site remediation involves the removal of polluted materials, soil or groundwater and then transporting them to other places for treatment. On-site remediation can be classified into in-situ remediation and ex-situ remediation. In-situ remediation can treat pollutants directly within the contaminated area without excavation. Off-site remediation and ex-situ remediation involve issues such as environmental changes and pollution movement. Therefore, compared with off-site remediation and ex-situ remediation, on-site remediation can reduce the cost and risk of transporting pollutants, save time, and avoid secondary pollution caused by the transportation process.

### SUMMARY

The in-situ ultrafine bubble circulation system provided by the present disclosure directly generates ultrafine bubbles beneath the ground-water table in the remediation well, so that the groundwater containing oil pollution is disturbed and floats to the ground-water table after remediating by ultrafine bubbles, which is beneficial for subsequent remediation operation. Furthermore, the ultrafine bubbles of the present disclosure can increase the dissolved oxygen in the groundwater and change the redox potential of the groundwater, which is beneficial to the growth of aerobic microorganisms, thereby increasing the remediation effectiveness.

At least one embodiment of the present disclosure provides an in-situ ultrafine bubble circulation system including a pumping well, a pump, an air compressor, a plurality of venture tubes, a remediation well, a hydrocyclone nozzle, and a well screen. The pumping well is drilled beneath a ground surface. The pump is located above the ground surface or in the pumping well, wherein the pump is fluidly connected to the pumping well and is configured to pump (or extract) a groundwater beneath the ground surface through a pipeline. The air compressor is located above the ground surface and fluidly connected to the pipeline, wherein the air compressor is configured to inject a gas into the groundwater within the pipeline before the groundwater is transported to the pump. The plurality of venture tubes is located above the ground surface and connected in series, wherein the venture tubes are fluidly connected to the pump, the pump is further configured to transport the groundwater to the venture tubes, and the venture tubes are configured to form a plurality of first ultrafine bubbles in the groundwater. The remediation well is drilled beneath the ground surface and separated from the pumping well. The hydrocyclone nozzle is located in the remediation well and disposed beneath a ground-water table, wherein the hydrocyclone nozzle is fluidly connected to the venture tubes and is configured to break up the first ultrafine bubbles in the groundwater into a plurality of second ultrafine bubbles when the groundwater from the venture tubes passes through the hydrocyclone nozzle. The well screen is located in the remediation well and around the hydrocyclone nozzle, wherein the well screen is disposed beneath the ground-water table, the well screen is configured to break up the second ultrafine bubbles in the groundwater through the hydrocyclone nozzle into a plurality of third ultrafine bubbles to remediate the groundwater beneath the ground surface using the third ultrafine bubbles.

In one embodiment of the present disclosure, the gas is air, oxygen, ozone, carbon dioxide, hydrogen, or combinations thereof.

In one embodiment of the present disclosure, when the gas injected into the pipeline is air, oxygen, ozone, or combinations thereof, a redox potential of the groundwater after remediating changes from a negative value to a positive value.

In one embodiment of the present disclosure, when the gas injected into the pipeline is carbon dioxide, hydrogen, or combinations thereof, a redox potential of the groundwater after remediating changes from a positive value to a negative value.

In one embodiment of the present disclosure, a total number of the venture tubes is 2 to 5.

In one embodiment of the present disclosure, a ratio of a wide-end diameter to a narrow-end diameter of each of the venture tubes is 12±3 mm: 5±3 mm.

In one embodiment of the present disclosure, a ratio of an inlet diameter to an outlet diameter of the hydrocyclone nozzle is 12±3 mm: 5±3 mm.

In one embodiment of the present disclosure, a water pressure of each of the venture tubes is 2 kg/cm³ to 3.5 kg/cm³.

In one embodiment of the present disclosure, the plurality of venture tubes is arranged in an S shape, and each of the venture tubes has a bending angle of 150 degrees to 180 degrees.

In one embodiment of the present disclosure, a diameter of each of the second ultrafine bubbles is 50 nm to 280 nm, and a concentration of the second ultrafine bubbles is 5.7×10⁷ particles/mL to 6.1×10⁷ particles/mL.

In one embodiment of the present disclosure, a slot opening of the well screen is 0.006 inch to 0.02 inch.

In one embodiment of the present disclosure, a diameter of each of the third ultrafine bubbles is 60 nm to 270 nm, and a concentration of the third ultrafine bubbles is 5.7×10⁷ particles/mL to 6.1×10⁷ particles/mL.

In one embodiment of the present disclosure, a diameter of each of the second ultrafine bubbles is less than a diameter of each of the first ultrafine bubbles.

In one embodiment of the present disclosure, a swirling flow region is formed between the hydrocyclone nozzle and the well screen, and the groundwater passing through the hydrocyclone nozzle is driven to form a swirling motion in the swirling flow region.

In one embodiment of the present disclosure, a diameter of the pumping well is 2 inches, and a diameter of the remediation well is 2 inches.

In one embodiment of the present disclosure, compared with a concentration of the second ultrafine bubbles having a diameter less than 100 nm in the second ultrafine bubbles, a concentration of the third ultrafine bubbles having a diameter less than 100 nm in the third ultrafine bubbles increases by at least 25.2%.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1A is a schematic view of an in-situ ultrafine bubble circulation system in accordance with one embodiment of the present disclosure.

FIG. 1B is an enlarged schematic view of the venture tube in FIG. 1A.

FIG. 2A is a layout plan of well sites in accordance with the Experimental Example of the present disclosure.

FIG. 2B is a 3D layout of well sites in FIG. 2A.

FIG. 3 is a schematic view of an in-situ bubble circulation system in accordance with the Experimental Example of the present disclosure.

FIG. 4A is a broken line graph of the redox potential of the monitoring well P1 in accordance with the Experimental Example of the present disclosure.

FIG. 4B is a broken line graph of the redox potential of the monitoring well P2 in accordance with the Experimental Example of the present disclosure.

FIG. 4C is a broken line graph of the redox potential of the monitoring well P3 in accordance with the Experimental Example of the present disclosure.

FIG. 4D is a broken line graph of the redox potential of the monitoring well P4 in accordance with the Experimental Example of the present disclosure.

FIG. 4E is a broken line graph of the redox potential of the monitoring well P5 in accordance with the Experimental Example of the present disclosure.

FIG. 5A is a redox potential distribution map of the first stage in accordance with the Experimental Example of the present disclosure.

FIG. 5B is a redox potential distribution map of the second stage in accordance with the Experimental Example of the present disclosure.

FIG. 5C is a redox potential distribution map of the third stage in accordance with the Experimental Example of the present disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

In the present specification, a range represented by “one value to another value” is a summary representation that avoids enumerating all the values in the range in the specification. Therefore, the recitation of a particular numerical range covers any numerical value within the numerical range and the smaller numerical range defined by any numerical values within the numerical range, as if the arbitrary value and the smaller numerical range are expressly stated in the specification.

A currently known conventional microbubble system for groundwater remediation first forms the water containing the microbubbles above the ground surface, then transports the water containing the microbubbles to the groundwater beneath the ground-water table using a pump. However, during the transportation process, the water containing microbubbles would cause the microbubbles to collide with each other, which leads to the diameter of the microbubbles become larger. The diameter of the microbubbles may even be so large that the microbubbles float to the ground-water table and disappear. Therefore, the remediation effectiveness of the traditional microbubble system is poor.

The “fluidly connected to” used herein may be understood as one element being directly adjacent to and physically connected to another element, such that the fluid (for example, he groundwater and/or ultrafine bubbles in the groundwater) may communicate between the two elements. The “ultrafine bubbles” herein refers to nano-sized bubbles.

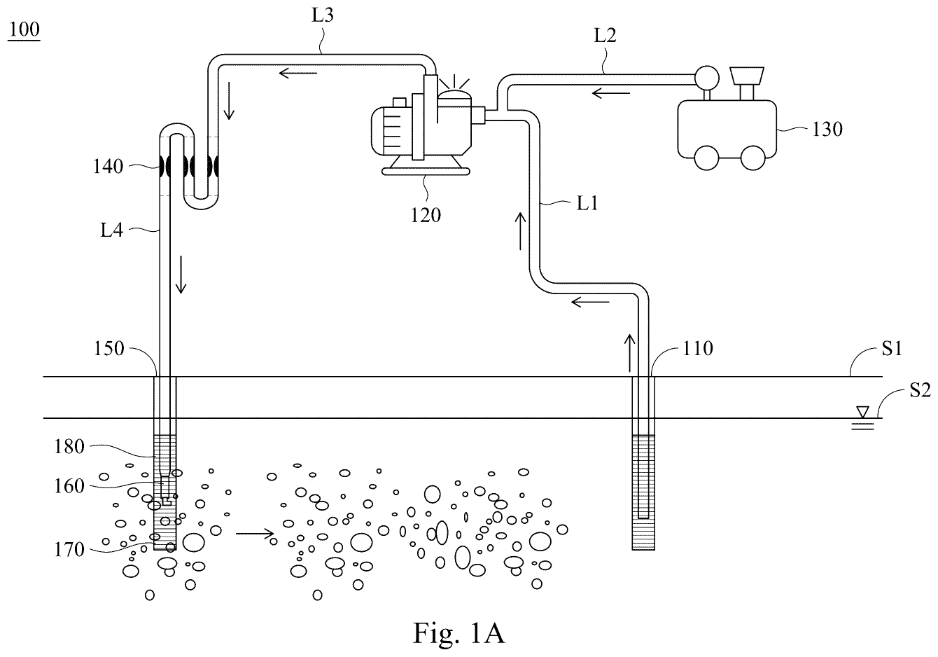

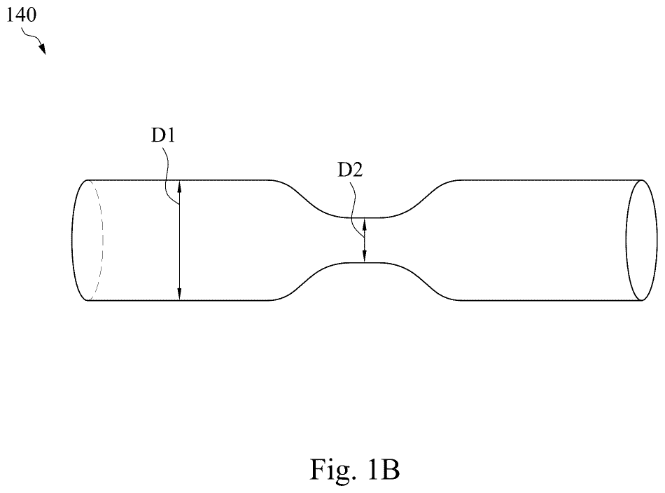

FIG. 1A is a schematic view of an in-situ ultrafine bubble circulation system 100 in accordance with one embodiment of the present disclosure. The arrows shown in FIG. 1A represent the direction of fluid transport. In-situ ultrafine bubble circulation system 100 includes a pumping well 110, a pump 120, an air compressor 130, a plurality of venture tubes 140, a remediation well 150, a hydrocyclone nozzle 160, and a well screen 170.

Referring to FIG. 1A, the pumping well 110 is drilled beneath a ground surface S1. In one example, a diameter of the pumping well 110 is 2 inches. The pump 120 is located above the ground surface S1 and fluidly connected to the pumping well 110. In other example, the pump 120 may be, for example, a submersible pump, wherein the submersible pump is located in the pumping well 110. The pump 120 is configured to pump (or extract) the groundwater from beneath the ground surface S1 through the pipeline L1 via the pumping well 110. The inverted triangle in FIG. 1A represent a ground-water table S2 located below the ground surface S1. Specifically, one end of the pipeline L1 is located in the pumping well 110 beneath the ground-water table S2, another end of the pipeline L1 is connected to the pump 120, such that the pump 120 can pump (or extract) the groundwater beneath the ground-water table S2.

Referring to FIG. 1A, the air compressor 130 is located above the ground surface S1 and fluidly connected to the pipeline L1. The air compressor 130 is configured to inject a gas into the groundwater within the pipeline L1 before the groundwater is transported to pump 120 through the pipeline L1. Specifically, one end of a pipeline L2 is connected to the pipeline L1, and the gas generated by the air compressor 130 is injected into the groundwater within the pipeline L1 through the pipeline L2. In some embodiments, the above gas is air, oxygen, ozone, carbon dioxide, hydrogen, or combinations thereof.

Referring to FIG. 1A, a plurality of venture tubes 140 is located above the ground surface S1 and connected in series. The venture tubes 140 are fluidly connected to the pump 120. The pump 120 is further configured to transport the groundwater to the venture tubes 140, and the venture tubes 140 are configured to form a plurality of first ultrafine bubbles in the groundwater. Specifically, as shown in FIG. 1A, the venture tubes 140 are fluidly connected to the pump 120 through a pipeline L3. In the flow direction of the groundwater, the plurality of first ultrafine bubbles is formed in the pipeline L4 downstream of the venture tubes 140.

In some embodiments, a total number of the venture tubes 140 is 2 to 5, such as 3 or 4. If the total number of the venture tubes 140 was less than 2, it may not generate sufficient amount of the first ultrafine bubbles, and the diameter of the first ultrafine bubbles may be too large, which is disadvantageous to the subsequent groundwater remediation. If the total number of the venture tube 140 was greater than 5, it may cause pressure loss so that the flow rate of the fluid may decrease and the friction of the boundary layer may decrease, resulting in the decrease in the number (concentration) of the first ultrafine bubbles and the increase in the diameter of the first ultrafine bubbles, which is disadvantageous to the subsequent groundwater remediation. Therefore, when the total number of the venture tubes 140 is 2 to 5, it is beneficial to subsequently form a plurality of third ultrafine bubbles with a specific diameter and a specific concentration, and is beneficial to the subsequent groundwater remediation.

In some embodiments, a water pressure of each venture tube 140 may be selectively 2 kg/cm³ to 3.5 kg/cm³, such as 2.5 kg/cm³ or 3 kg/cm³, but is not limited thereto. When the water pressure of the venture tube 140 is in the above range, it is beneficial to subsequently form the third ultrafine bubbles with a specific diameter and a specific concentration, and is beneficial to the subsequent groundwater remediation.

In one example, the plurality of venture tube 140 may be selectively arranged in an S shape, but is not limited thereto. When the venture tubes 140 are arranged in the S shape, the space of the in-situ ultrafine bubble circulation system 100 can be saved. In one example, a bending angle of each venture tube 140 is 150 degrees to 180 degrees, such as 160 degrees or 170 degrees. When the bending angle is in the above range, the collision frequency between the water flow and the bubbles can be increased to increase the concentration of the first ultrafine bubbles per unit volume.

FIG. 1B is an enlarged schematic view of the venture tube 140 in FIG. 1A. In some embodiments, a ratio of a wide-end diameter D1 to a narrow-end diameter D2 of each venture tube 140 may be selectively 12±3 mm: 5±3 mm, such as 9 mm: 2 mm, 11 mm: 4 mm, 13 mm: 6 mm, or 15 mm: 8 mm, but is not limited thereto. When the ratio of the wide-end diameter D1 to the narrow-end diameter D2 is in the above range, it is beneficial to subsequently form the third ultrafine bubbles with the specific diameter and the specific concentration, and is beneficial to the subsequent groundwater remediation.

Referring to FIG. 1A, the remediation well 150 is drilled beneath the ground surface S1 and separated from the pumping well 110. The remediation well 150 is fluidly connected to the venture tube 140 through the pipeline L4. In one example, a diameter of the remediation well 150 is 2 inches. In some embodiments, when the remediation well 150 and the pumping well 110 are separated by a certain distance, it is beneficial to the circulation of groundwater below the ground-water table S2 in the area where the in-situ ultrafine bubble circulation system 100 is located.

Referring to FIG. 1A, the hydrocyclone nozzle 160 is located in the remediation well 150 and disposed beneath the ground-water table S2. The hydrocyclone nozzle 160 is fluidly connected to the plurality of venture tubes 140. The hydrocyclone nozzle 160 is configured to break up the first ultrafine bubbles in the groundwater into the second ultrafine bubbles when the groundwater from the venture tubes 140 passes through the hydrocyclone nozzle 160. Specifically, the venture tubes 140 is fluidly connected to the hydrocyclone nozzle 160 through the pipeline L4, wherein one end of the pipeline L4 is located above the ground surface S1, and another end of the pipeline L4 is located below the ground-water table S2 in the remediation well 150. In some embodiments, a ratio of an inlet diameter to an outlet diameter of the hydrocyclone nozzle 160 is 12±3 mm: 5±3 mm.

In some embodiments, a diameter of each second ultrafine bubble may be selectively 50 nm to 280 nm, such as 100 nm, 150 nm, 200 nm, or 25 0nm, but is not limited thereto. When the diameter of each second ultrafine bubble is in the above range, it is beneficial to subsequently form the third ultrafine bubbles with the specific diameter and the specific concentration, and is beneficial to the subsequent groundwater remediation. In one example, a diameter D90 of the second ultrafine bubbles is 276.6 nm, a diameter D50 of the second ultrafine bubbles is 128.1 nm, and a diameter D10 of the second ultrafine bubbles is 53.3 nm. In some embodiments, the diameter of each second ultrafine bubble is less than the diameter of each first ultrafine bubble.

In some embodiments, a concentration of the second ultrafine bubbles may be selectively 5.7×10⁷ particles/mL to 6.1×10⁷ particles/mL, such as 5.8×10⁷ particles/mL, 5.9×10⁷ particles/mL, or 6×10⁷ particles/mL, but is not limited thereto. When the concentration of the second ultrafine bubbles is in the above range, it is beneficial to subsequently form the third ultrafine bubbles with the specific diameter and the specific concentration, and is beneficial to the subsequent groundwater remediation.

Referring to FIG. 1A, the well screen 170 is located in the remediation well 150 and around the hydrocyclone nozzle 160. In other words, the hydrocyclone nozzle 160 is disposed in the well screen 170. The well screen 170 is disposed beneath the ground-water table S2. The well screen 170 is configured to break up the second ultrafine bubbles in the groundwater through the hydrocyclone nozzle 160 into third ultrafine bubbles to remediate the groundwater beneath the ground surface S1 using the third ultrafine bubbles.

In some embodiments, a slot opening of the well screen 170 may be selectively 0.006 inch to 0.02 inch, such as 0.008 inch, 0.01 inch, 0.012 inch, 0.014 inch, 0.016 inch, or 0.018 inch, but is not limited thereto. When the slot opening of the well screen 170 is in the above range, it is beneficial to the subsequent groundwater remediation.

In some embodiments, a diameter of each third ultrafine bubble may be selectively 60 nm to 270 nm, such as 100 nm, 150 nm, 200 nm, or 250 nm, but is not limited thereto. When the diameter of the third ultrafine bubbles is in the above range, it is beneficial to the subsequent groundwater remediation. In one example, a diameter D90 of the third ultrafine bubbles is 267.1 nm, a diameter D50 of the third ultrafine bubbles is 125.7 nm, and a diameter D10 of the third ultrafine bubbles is 61.1 nm.

In some embodiments, a concentration of the third ultrafine bubbles may be selectively 5.7×10⁷ particles/mL to 6.1×10⁷ particles/mL, such as 5.8×10⁷ particles/mL, 5.9×10⁷ particles/mL, or 6×10⁷ particles/mL, but is not limited thereto. When the concentration of the third ultrafine bubbles, it is beneficial to the subsequent groundwater remediation.

In one example, compared with the concentration of the second ultrafine bubbles having the diameter less than 100 nm in the second ultrafine bubbles, the concentration of the third ultrafine bubbles having the diameter less than 100 nm in the third ultrafine bubbles increases by at least 25.2%.

In some embodiments, referring to FIG. 1A, a swirling flow region 180 is formed between the hydrocyclone nozzle 160 and the well screen 170. The swirling flow region 180 is not large, but it is sufficient to induce a swirling motion of the groundwater passing through the hydrocyclone nozzle 160. The swirling motion can increase the flow of groundwater beneath the ground-water table S2, which is beneficial to the circulation of groundwater below the ground-water table S2 in the area where the in-situ ultrafine bubble circulation system 100 is located.

In some embodiments, when the gas injected into the pipeline L1 (referring to FIG. 1A) is air, oxygen, ozone, or combinations thereof, the redox potential (ORP) of the remediated groundwater changes from a negative value (anaerobic environment) to a positive value (aerobic environment). In some embodiments, when the gas injected into the pipeline L1 (referring to FIG. 1A) is carbon dioxide, hydrogen, or combinations thereof, the redox potential of the remediated groundwater changes from a positive value (aerobic environment) to a negative value (anaerobic environment).

The venture tubes 140, the hydrocyclone nozzle 160, and the well screen 170 in the in-situ ultrafine bubble circulation system 100 disclosed herein are used to directly form the third ultrafine bubbles with the specific diameter and the specific concentration beneath the ground-water table S2, so that the third ultrafine bubbles can easily stay in the water. Specifically, the third ultrafine bubbles of the present disclosure are nano-sized bubbles and thus easily stay in water. More specifically, compared with micro-sized microbubbles, the nano-sized ultrafine bubbles of the present disclosure tend to stay suspended in water more easily. The longer the ultrafine bubbles are suspended, the easier it is to maintain the dissolved oxygen in the water, so the better effectiveness for groundwater remediation.

The in-situ ultrafine bubble circulation system 100 of the present disclosure may be applied to, for example, oil-contaminated groundwater, but is not limited thereto. For example, by directly generating ultrafine bubbles beneath the ground-water table S2 in the remediation well 150, the groundwater containing oil pollution is disturbed and floated to the ground-water table S2 after treatment by the ultrafine bubbles, which is beneficial to the subsequent groundwater remediation. Furthermore, the ultrafine bubbles of the present disclosure can increase the dissolved oxygen in groundwater and change the redox potential of groundwater, which is beneficial to the growth of aerobic microorganisms, thereby increasing the remediation effectiveness.

The following Experimental Example is used to describe the applications of the present disclosure, but they are not intended to limit the present disclosure. Those skilled in the art may make various changes and alterations herein without departing from the spirit and scope of the present disclosure.

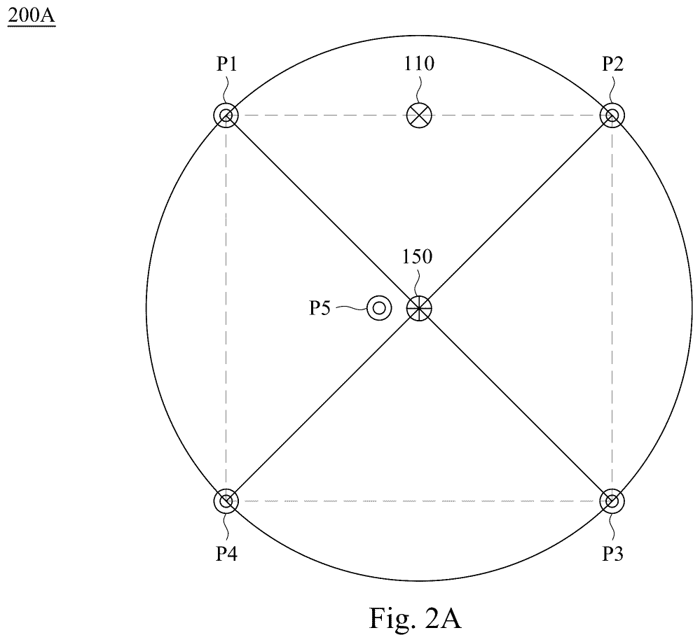

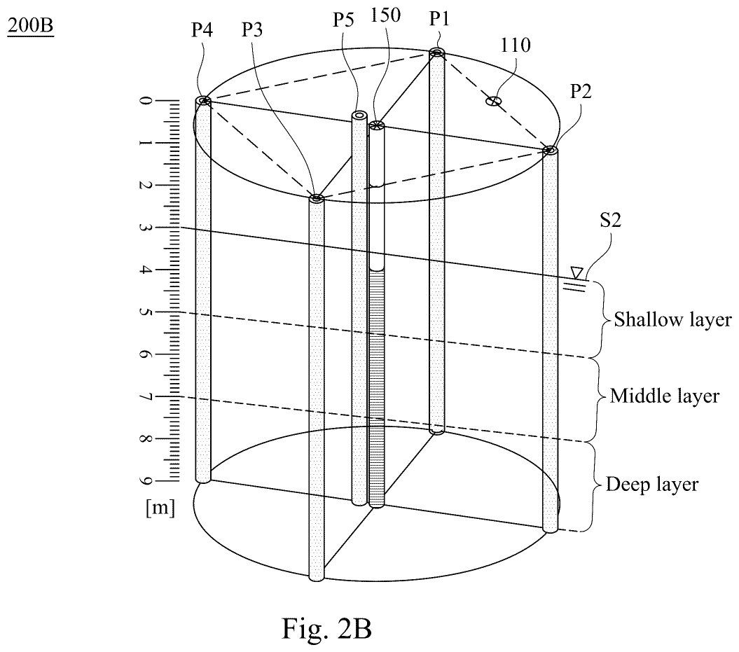

FIG. 2A is a layout plan 200A of well sites in accordance with the Experimental Example of the present disclosure. The layout plan 200A included the pumping well 110, the remediation well 150, and a plurality of monitoring wells P1 to P5. With the remediation well 150 as the center, the monitoring wells P1 to P4 were arranged symmetrically around the remediation well 150. The monitoring well P5 was adjacent to the remediation well 150. A distance between the monitoring well P5 and the remediation well 150 was less than a distance between any one of the monitoring wells P1 to P4 and the remediation well 150. The site of the Experimental Example was located in basalt formations.

It could be understood that the layout plan 200A of well sites in FIG. 2A is merely a schematic diagram. For the sake of simplicity, other devices and components in the in-situ ultrafine bubble circulation system 100 of FIG. 1A were not shown in these well sites.

FIG. 2B is a 3D layout 200B of well sites in FIG. 2A. As shown in FIG. 2B, the pumping well 110, the remediation well 150, and the monitoring wells P1 to P5 were all constructed at a depth of around 9 meters beneath the ground surface (i.e., the ground surface S1 in FIG. 1A).

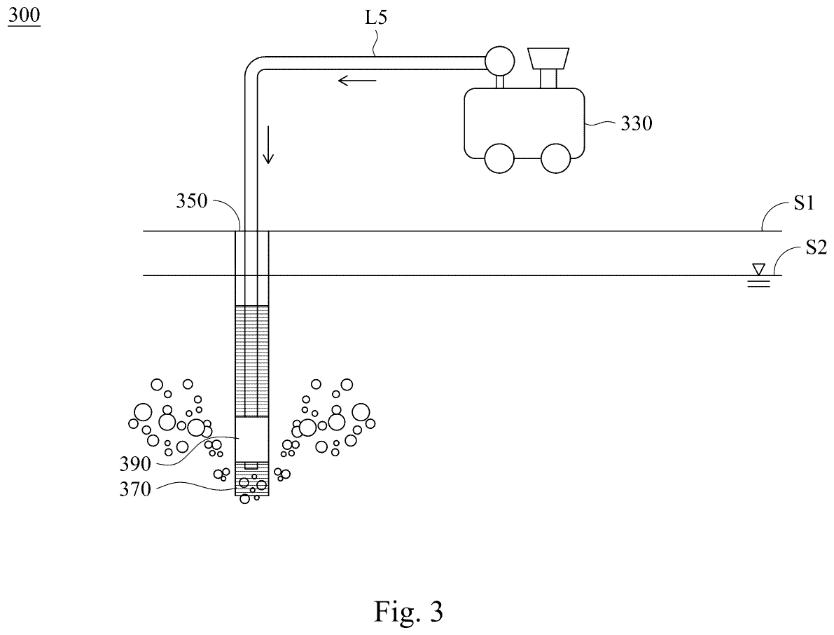

FIG. 3 is a schematic view of an in-situ bubble circulation system 300 in accordance with the Experimental Example of the present disclosure. The in-situ bubble circulation system 300 in FIG. 3 was different from the in-situ ultrafine bubble circulation system 100 in FIG. 1A. In the in-situ bubble circulation system 300, the gas (for example, air, oxygen, ozone, carbon dioxide, hydrogen, or combinations thereof) was generated directly in the groundwater beneath the ground-water table S2.

As shown in FIG. 3, the in-situ bubble circulation system 300 included an air compressor 330, a pipeline L5, a remediation well 350, a well screen 370, and a packer 390. The air compressor 330, the remediation well 350, and the well screen 370 in the in-situ bubble circulation system 300 were the same as the air compressor 130, the remediation well 150, and the well screen 170 in the in-situ ultrafine bubble circulation system 100 (referring to FIG. 1A), and the details thereof are not repeatedly described. In other words, the in-situ bubble circulation system 300 did not have the pumping well 110, the venture tubes 140, and the hydrocyclone nozzle 160 in the in-situ ultrafine bubble circulation system 100. The in-situ bubble circulation system 300 generated air bubbles directly in the groundwater beneath the ground-water table S2 using only the air compressor 330.

In the example of FIG. 3, one end of the pipeline L5 was connected to the air compressor 330, and another end of the pipeline L5 was located beneath the ground-water table S2 and passed through the packer 390. Because the in-situ bubble circulation system 300 generates air directly in the groundwater beneath the ground-water table S2, the pipeline L5 did not contain the groundwater. Compared with the in-situ ultrafine bubble circulation system 100 of FIG. 1A, a diameter of the bubbles in the in-situ bubble circulation system 300 of FIG. 3 was larger, so the buoyancy of the bubbles was also larger, making the bubbles disappear more easily.

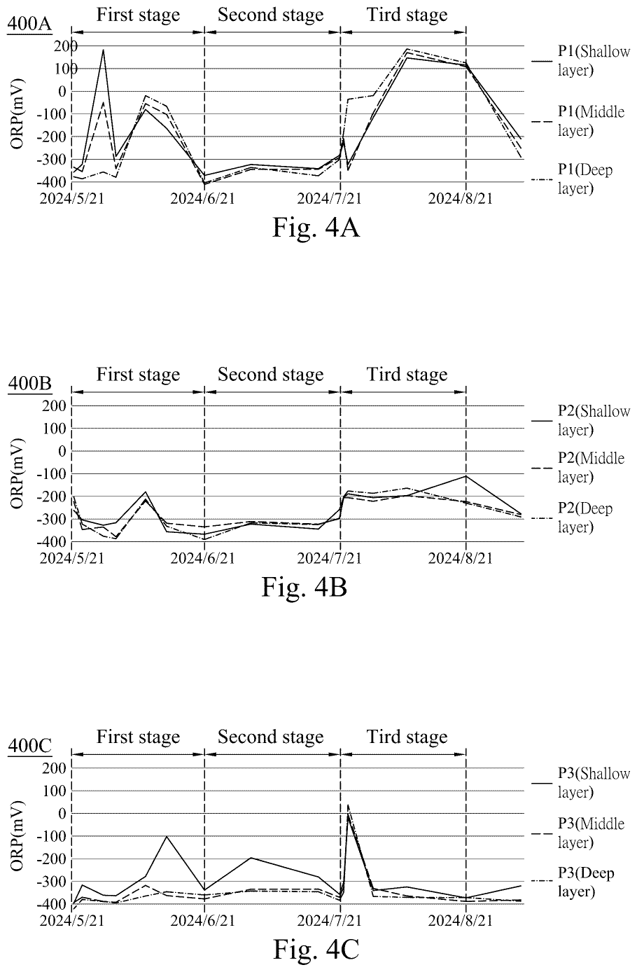

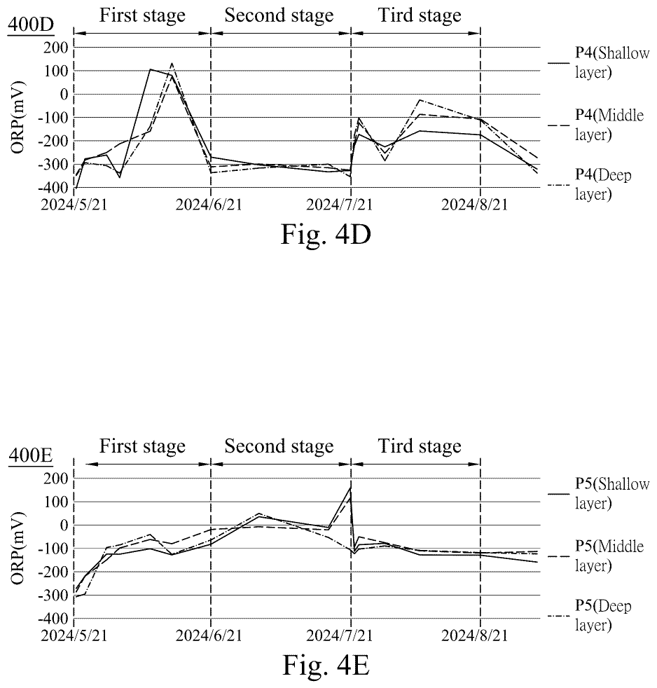

Experimental Example included three stages of bubble injection, wherein the system and gas used in each stage were different. In the first stage, the in-situ ultrafine bubble circulation system 100 in FIG. 1A was used, and the air compressor 130 injected air. In the second stage, the in-situ bubble circulation system 300 in FIG. 3 was used, and the air compressor 130 injected air. The “second stage” herein may be also referred to as air sparging. In the third stage, the in-situ ultrafine bubble circulation system 100 in FIG. 1A was used, and the air compressor 130 injected ozone. The remediation results of the groundwater refer to FIG. 4A to FIG. 4E.

FIG. 4A is a broken line graph 400A of the redox potential of the monitoring well P1 in accordance with the Experimental Example of the present disclosure. FIG. 4B is a broken line graph 400B of the redox potential of the monitoring well P2 in accordance with the Experimental Example of the present disclosure. FIG. 4C is a broken line graph 400C of the redox potential of the monitoring well P3 in accordance with the Experimental Example of the present disclosure. FIG. 4D is a broken line graph 400D of the redox potential of the monitoring well P4 in accordance with the Experimental Example of the present disclosure. FIG. 4E is a broken line graph 400E of the redox potential of the monitoring well P5 in accordance with the Experimental Example of the present disclosure. Referring to FIG. 2B and FIG. 4A to FIG. 4E, the monitoring wells P1 to P5 measured the redox potential of the shallow layer, middle layer, and deep layer respectively over time.

As shown in FIG. 2B, the “shallow layer” herein refers to an area with a depth of about 3 meters to 5 meters, the “middle layer” herein refers to an area with a depth of about 5 meters to 7 meters, and the “deep layer” herein refers to an area with a depth of about 7 meters to 9 meters.

In FIG. 4A to FIG. 4E, the first stage was from May 5, 2024 to Jun 6, 2024, the second stage was from Jun. 21, 2024 to Jul. 21, 2024, and the third stage was from Jul 7, 2024 to Aug. 21, 2024.

It can be known from the results of FIG. 4A and FIG. 4D that the ORP of the monitoring wells P1 and P4 in the first stage and the third stage was significant higher than the ORP of the monitoring wells P1 and P4 in the second stage.

It can be known from the results of FIG. 4B and FIG. 4C that there were no significant changes in the ORP of the monitoring wells P2 and P3 in the first stage, the second stage, and the third stage. This is because of the relationship between groundwater flow and basalt fractures, so the remediated groundwater did not flow to the monitoring wells P2 and P3.

It can be known from the results of FIG. 4E that the ORP of the monitoring well P5 in the second stage was higher than the ORP of the monitoring well P5 in the first stage and the third stage. Because basalt formations had many cracks, pollutants could easily accumulate in the cracks, causing poor fluidity of the groundwater. In the second stage, a short-circuiting of groundwater occurred at the monitoring well P5, and almost all the air flowed toward the path of the monitoring well P5. Therefore, the ORP of the monitoring well P5 in the second stage increased instead. Also, because the injected air occurred short-circuiting in the monitoring well P5, almost no air flowed to other monitoring wells (for example, the monitoring wells P1 and P4), and thus the ORP of other monitoring wells in the second stage was lower than that in the first and third stages.

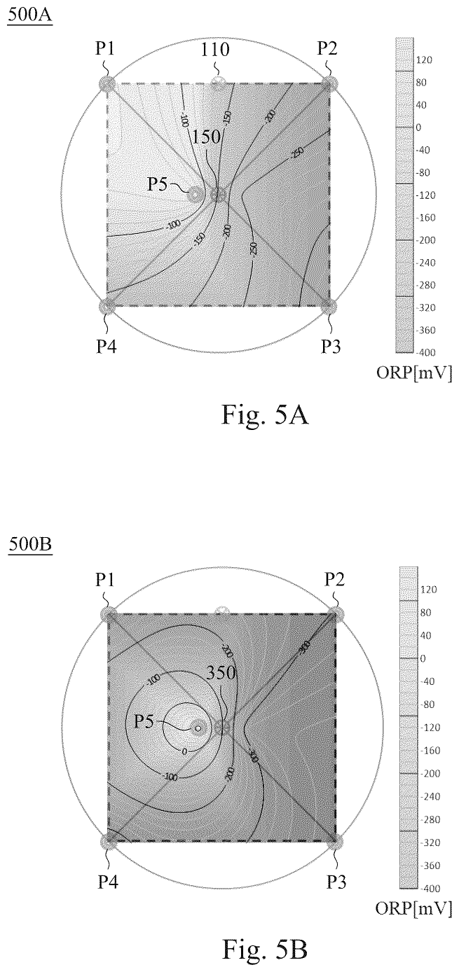

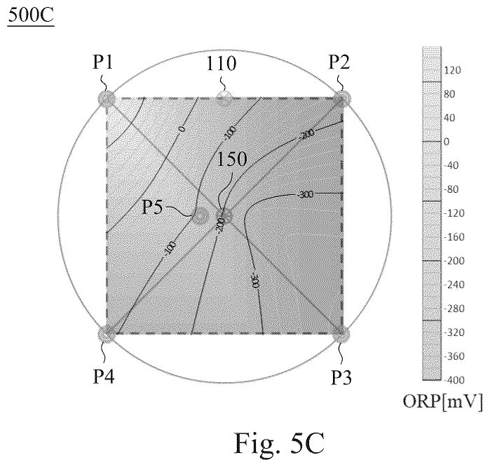

FIG. 5A is a redox potential distribution map 500A of the first stage in accordance with the Experimental Example of the present disclosure. FIG. 5B is a redox potential distribution map 500B of the second stage in accordance with the Experimental Example of the present disclosure. FIG. 5C is a redox potential distribution map 500C of the third stage in accordance with the Experimental Example of the present disclosure.

It can be known from the results of FIG. 5A to FIG. 5C that, in the first stage of FIG. 5A and the third stage of FIG. 5C, the remediated groundwater could not only flow to the nearest monitoring well P5, but also flow to the monitoring wells P1 and P4. Therefore, compared with the second stage (the gas injecting to the monitoring well P5 occurred short-circuiting) in FIG. 5B, the in-situ ultrafine bubble circulation system 100 (i.e., the first stage and the third stage) of the present disclosure improved the fluidity of groundwater and had a better remediation effectiveness.

Compared with the bubbles generated by the in-situ bubble circulation system 300 (referring to FIG. 3) in the second stage, the third ultrafine bubbles generated by the in-situ ultrafine bubble circulation system 100 (Referring to FIG. 1A) had a smaller diameter and a higher concentration. Therefore, the third ultrafine bubbles stayed in the groundwater longer and were transported over a longer distance, thus having a better remediation effectiveness.

In summary, the in-situ ultrafine bubble circulation system provided by the present disclosure directly generates ultrafine bubbles beneath the ground-water table in the remediation well, so that the groundwater containing oil pollution is disturbed and floats to the ground-water table after remediating by ultrafine bubbles, which is beneficial for subsequent remediation operation. The ultrafine bubbles of the present disclosure also can increase the dissolved oxygen in the groundwater and change the redox potential of the groundwater, which is beneficial to the growth of aerobic microorganisms, thereby increasing the remediation effectiveness. Furthermore, because the in-situ ultrafine bubble circulation system provided by the present disclosure includes the pumping well for extracting groundwater and the remediation well for injecting groundwater, the groundwater beneath the ground-water table can form a circulation system. The in-situ ultrafine bubble circulation system can reduce the cost and risk of transporting pollutants, eliminate the need for additional water sources and save remediation costs, save time, and avoid secondary pollution caused by the transportation process.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. An in-situ ultrafine bubble circulation system, comprising:
a pumping well drilled beneath a ground surface;
a pump located above the ground surface or in the pumping well, wherein the pump is fluidly connected to the pumping well and is configured to pump a groundwater beneath the ground surface through a pipeline;
an air compressor located above the ground surface and fluidly connected to the pipeline, wherein the air compressor is configured to inject a gas into the groundwater within the pipeline before the groundwater is transported to the pump;
a plurality of venture tubes located above the ground surface and connected in series, wherein the venture tubes are fluidly connected to the pump, the pump is further configured to transport the groundwater to the venture tubes, and the venture tubes are configured to form a plurality of first ultrafine bubbles in the groundwater;
a remediation well drilled beneath the ground surface and separated from the pumping well;
a hydrocyclone nozzle located in the remediation well and disposed beneath a ground-water table, wherein the hydrocyclone nozzle is fluidly connected to the venture tubes and is configured to break up the first ultrafine bubbles in the groundwater into a plurality of second ultrafine bubbles when the groundwater from the venture tubes passes through the hydrocyclone nozzle; and
a well screen located in the remediation well and around the hydrocyclone nozzle, wherein the well screen is disposed beneath the ground-water table, the well screen is configured to break up the second ultrafine bubbles in the groundwater through the hydrocyclone nozzle into a plurality of third ultrafine bubbles to remediate the groundwater beneath the ground surface using the third ultrafine bubbles.

2. The in-situ ultrafine bubble circulation system of claim 1, wherein the gas is air, oxygen, ozone, carbon dioxide, hydrogen, or combinations thereof.

3. The in-situ ultrafine bubble circulation system of claim 1, wherein, when the gas injected into the pipeline is air, oxygen, ozone, or combinations thereof, a redox potential of the groundwater after remediating changes from a negative value to a positive value.

4. The in-situ ultrafine bubble circulation system of claim 1, wherein, when the gas injected into the pipeline is carbon dioxide, hydrogen, or combinations thereof, a redox potential of the groundwater after remediating changes from a positive value to a negative value.

5. The in-situ ultrafine bubble circulation system of claim 1, wherein a total number of the venture tubes is 2 to 5.

6. The in-situ ultrafine bubble circulation system of claim 1, wherein a ratio of a wide-end diameter to a narrow-end diameter of each of the venture tubes is 12±3 mm: 5±3 mm.

7. The in-situ ultrafine bubble circulation system of claim 1, wherein a ratio of an inlet diameter to an outlet diameter of the hydrocyclone nozzle is 12±3 mm: 5±3 mm.

8. The in-situ ultrafine bubble circulation system of claim 1, wherein a water pressure of each of the venture tubes is 2 kg/cm³ to 3.5 kg/cm³.

9. The in-situ ultrafine bubble circulation system of claim 1, wherein the plurality of venture tubes is arranged in an S shape, and each of the venture tubes has a bending angle of 150 degrees to 180 degrees.

10. The in-situ ultrafine bubble circulation system of claim 1, wherein a diameter of each of the second ultrafine bubbles is 50 nm to 280 nm, and a concentration of the second ultrafine bubbles is 5.7×10⁷ particles/mL to 6.1×10⁷ particles/mL.

11. The in-situ ultrafine bubble circulation system of claim 1, wherein a slot opening of the well screen is 0.006 inch to 0.02 inch.

12. The in-situ ultrafine bubble circulation system of claim 1, wherein a diameter of each of the third ultrafine bubbles is 60 nm to 270 nm, and a concentration of the third ultrafine bubbles is 5.7×10⁷ particles/mL to 6.1×10⁷ particles/mL.

13. The in-situ ultrafine bubble circulation system of claim 1, wherein a diameter of each of the second ultrafine bubbles is less than a diameter of each of the first ultrafine bubbles.

14. The in-situ ultrafine bubble circulation system of claim 1, wherein a swirling flow region is formed between the hydrocyclone nozzle and the well screen, and the groundwater passing through the hydrocyclone nozzle is driven to form a swirling motion in the swirling flow region.

15. The in-situ ultrafine bubble circulation system of claim 1, wherein a diameter of the pumping well is 2 inches, and a diameter of the remediation well is 2 inches.

16. The in-situ ultrafine bubble circulation system of claim 1, wherein, compared with a concentration of the second ultrafine bubbles having a diameter less than 100 nm in the second ultrafine bubbles, a concentration of the third ultrafine bubbles having a diameter less than 100 nm in the third ultrafine bubbles increases by at least 25.2%.
